(19) United States
(12) Patent Application Publication
(10) Pub. No.: US 2026/0218437 A1
(43) Pub. Date: Jul. 30, 2026

(54) WIRING HARNESS HOUSING FOR AN APPLIANCE

(71) Applicant: Haier US Appliance Solutions, Inc., Wilmington, DE (US)

(72) Inventor: Tanner Davis Gunn, Louisville, KY (US)

(21) Appl. No.: 19/039,869

(22) Filed: Jan. 29, 2025

(51) Int. Cl. D06F 39/12; H01R 13/639

(52) U.S. Cl. CPC D06F 39/12; H01R 13/639

(57) ABSTRACT

An appliance and wiring harness housing are provided, the wiring harness housing including a plurality of sidewalls forming a routing passage extending along a lengthwise direction between a first open end and a second open end. A first harness attachment interface is positioned vertically outward relative to a second harness attachment interface. The first harness attachment is configured to receive a first wiring harness along the routing passage vertically outward from a second harness attachment configured to receive the second wiring harness along the routing passage. The wiring harness housing is a unitary, monolithic component including the plurality of sidewalls, the first harness attachment interface, and the second harness attachment interface.

### FIELD OF THE INVENTION

The present subject matter relates generally to appliances, and more particularly to wiring harness housings for an appliance.

### BACKGROUND OF THE INVENTION

Appliances may generally include an electrically-driven component or subassembly installed into a cabinet and electrically coupled to a controller or power source through a wiring harness. For instance, washing machine appliances generally include a wash tub subassembly housed within a cabinet. A wash basket is rotatably mounted within the wash tub and defines a wash chamber for receipt of articles for washing during a wash cycle. During the wash cycle, the wash basket rotates and agitates articles or wash fluid to wash the articles. The wash tub may move or vibrate within the cabinet during the wash cycle. A wiring harness operably electrically couples to various electrically-driven or electronically-controlled components at the appliance, such as to the wash tub subassembly to provide power to the wash tub and controlling rotation of the wash basket, or to the cabinet or door for locking the door, or to a user interface and display, etc.

Properly restraining the wiring harness in an appliance is important for preventing unsafe operating conditions, losses in appliance function, and mitigating damage to the wiring harness during assembly and operation. Proper restraint of the wiring harness further mitigates undesired vibration, noise, and electromagnetic interference.

Additionally, appliances are limited in interior space within the cabinet for routing and properly restraining a plurality of wiring harnesses. For instance, a plurality of wiring harnesses may need to cross one another, route along the same wall, or occupy similar spaces.

Accordingly, a structure for restraining and routing a wiring harness addressing one or more of the aforementioned issues would be advantageous and beneficial. Furthermore, a structure for restraining and routing a plurality of wiring harnesses addressing one or more of the aforementioned issues would be advantageous and beneficial.

### BRIEF DESCRIPTION OF THE INVENTION

Aspects and advantages of the invention will be set forth in part in the following description, or may be obvious from the description, or may be learned through practice of the invention.

An aspect of the present disclosure is directed to an appliance including a cabinet having a plurality of walls, the plurality of walls forming an interior into which an electrically-driven component is disposable. A controller is configured to operate the electrically-driven component. A wiring harness assembly couples the controller and the electrically-driven component. The wiring harness assembly includes a first wiring harness and a second wiring harness. A wiring harness housing through which the wiring harness assembly is routed includes a plurality of sidewalls forming a routing passage extending along a lengthwise direction between a first open end and a second open end. The first wiring harness and the second wiring harness are extendable into the routing passage in vertically adjacent arrangement to one another. The plurality of sidewalls and routing passage extend substantially along the lengthwise direction. The wiring harness housing includes a first harness attachment interface and a second harness attachment interface. The first harness attachment interface is positioned vertically outward relative to the second harness attachment interface. The first harness attachment is configured to receive the first wiring harness along the routing passage vertically outward from the second harness attachment configured to receive the second wiring harness along the routing passage. The wiring harness housing is a unitary, monolithic component including the plurality of sidewalls, the first harness attachment interface, and the second harness attachment interface.

An aspect of the present disclosure is directed to a wiring harness housing for an appliance. The wiring harness housing includes a plurality of sidewalls forming a routing passage extending along a lengthwise direction between a first open end and a second open end. The plurality of sidewalls and routing passage extend substantially along the lengthwise direction. The wiring harness housing includes a first harness attachment interface and a second harness attachment interface. The first harness attachment interface is positioned vertically outward relative to the second harness attachment interface. The first harness attachment is configured to receive a first wiring harness along the routing passage vertically outward from a second harness attachment configured to receive the second wiring harness along the routing passage. The wiring harness housing includes a first housing portion rotatable relative to a second housing portion at a hinge at one of the plurality of sidewalls. The hinge permits the wiring harness housing to bend at the hinge to position the first housing portion and second housing portion alongside one another along the lengthwise direction. The wiring harness housing is a unitary, monolithic component including the plurality of sidewalls, the first harness attachment interface, the second harness attachment interface, and the hinge.

An aspect of the present disclosure is directed to an appliance including a cabinet having a plurality of walls, the plurality of walls forming an interior into which an electrically-driven component is disposable. A controller is configured to operate the electrically-driven component. A wiring harness assembly couples the controller and the electrically-driven component. A wiring harness housing through which the wiring harness assembly is routed includes a plurality of sidewalls forming a routing passage through which the wiring harness assembly is extendable. The plurality of sidewalls and routing passage extend substantially along a lengthwise direction. The wiring harness housing includes a plurality of harness attachment interfaces positioned along the lengthwise direction at the plurality of sidewalls. The plurality of harness attachment interfaces are configured to retain the wiring harness assembly to the wiring harness housing along the routing passage. The wiring harness housing includes a first housing portion rotatable relative to a second housing portion at a hinge. The hinge permits the wiring harness housing to bend at the hinge to position the first housing portion and second housing portion alongside one another along the lengthwise direction. The wiring harness housing is a unitary, monolithic component including the plurality of sidewalls, the plurality of harness attachment interfaces, and the hinge.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a front load washing machine appliance according to exemplary embodiments of the present disclosure.

FIG. 2 provides a cross section view of the exemplary washing machine appliance of FIG. 1.

FIG. 3 provides a perspective view of an exemplary cabinet of an appliance and including an exemplary embodiment of a wiring harness housing in accordance with aspects of the present disclosure.

FIG. 4 provides a perspective view of the exemplary cabinet of FIG. 3 including an exemplary embodiment of a wiring harness housing in accordance with aspects of the present disclosure.

FIG. 5 provides a perspective view of the exemplary cabinet of FIG. 4 including an exemplary routing of a plurality of wiring harnesses at the wiring harness housings in accordance with aspects of the present disclosure.

FIG. 6 provides a perspective view of an embodiment of the wiring harness housing in accordance with aspects of the present disclosure.

FIG. 7 provides a perspective view of an embodiment of a wiring harness at a wiring harness housing in accordance with aspects of the present disclosure.

FIG. 8 provides a top plan view of an embodiment of a wiring harness housing in accordance with aspects of the present disclosure.

FIG. 9 provides a side view of the wiring harness housing of FIG. 8 in accordance with aspects of the present disclosure.

FIG. 10 provides a cross sectional view of an embodiment of a wiring harness housing including a vertically adjacent arrangement of wiring harnesses in accordance with aspects of the present disclosure.

FIG. 11 provides a side view of an embodiment of a wiring harness housing including a vertically adjacent arrangement of wiring harnesses in accordance with aspects of the present disclosure.

FIG. 12 provides a detailed side view of a first housing portion of the wiring harness housing of FIG. 11 in accordance with aspects of the present disclosure.

FIG. 13 provides a detailed side view of a second housing portion of the wiring harness housing of FIG. 11 in accordance with aspects of the present disclosure.

FIG. 14 provides a top plan view of an embodiment of a wiring harness housing in a folded state in accordance with aspects of the present disclosure.

FIG. 15 provides a top plan view of the wiring harness housing of FIG. 14 in an unfolded state in accordance with aspects of the present disclosure.

FIG. 16 provides a top plan view of the wiring harness housing of FIG. 14 in an unfolded state, including an exemplary routing of wiring harnesses, in accordance with aspects of the present disclosure.

FIG. 17 provides a detailed view of an embodiment of a detachment interface and a hinge of a wiring harness housing in accordance with aspects of the present disclosure.

FIG. 18 provides a detailed view of an embodiment of a detachment interface and a lock of a wiring harness housing in accordance with aspects of the present disclosure.

FIG. 19 provides a perspective view of an embodiment of an appliance including an embodiment of a wiring harness housing and portion of a wiring harness routing to an electrically-driven component in accordance with aspects of the present disclosure.

FIG. 20 provides a perspective view of an embodiment of an appliance including an embodiment of a wiring harness housing and exemplary routing of a plurality of wiring harnesses in accordance with aspects of the present disclosure.

FIG. 21 provides a perspective view of an embodiment of a portion of a wiring harness housing including a clip in an unfolded state in accordance with aspects of the present disclosure.

FIG. 22 provides a top plan view of the wiring harness housing of FIG. 21 in accordance with aspects of the present disclosure.

FIG. 23 provides a perspective view of the wiring harness housing of FIG. 21 in a folded state in accordance with aspects of the present disclosure.

FIG. 24 provides a perspective view of a portion of an embodiment of a wiring harness housing at a harness retainer attachment interface in accordance with aspects of the present disclosure.

FIG. 25 provides a perspective view of an embodiment of a first housing portion and a second housing portion of a wiring harness housing in accordance with aspects of the present disclosure.

FIG. 26 provides a perspective view of an embodiment of a wiring harness housing in accordance with aspects of the present disclosure.

FIG. 27 provides a cross sectional view of the wiring harness housing of FIG. 26 including exemplary wiring harnesses positioned thereat in accordance with aspects of the present disclosure.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a wiring harness housing for routing a wiring harness in a cabinet of an appliance is provided that address one or more of the aforementioned issues. Embodiments of the wiring harness housing may include one or more hinges configured as flexible, compliant members to permit positioning the housing in a folded state and an unfolded state. In an exemplary embodiment, the wiring harness housing may be assembled to one of the front or corner flanges on a washing machine appliance (e.g., a front load washer cabinet). The wiring harness may be assembled into a routing channel at the wiring harness housing and fastened using clips, ties, or other fasteners. The routing channel may extend along a wall of the cabinet, or around a plurality of walls of the cabinet. Walls at the housing may furthermore protect the wiring harness from pinching, shearing, tearing, rubbing, or other undesired contact, such as during assembly or disassembly of components, assemblies, subassemblies, etc. at or into the cabinet.

Embodiments of the wiring harness housing depicted and described herein further permit retention and routing of a plurality of wiring harnesses in the same housing, such as in vertically adjacent arrangement. Wiring harnesses may be preassembled into the housing and secured at harness attachment interfaces before assembling the housing into the cabinet, which may facilitate assembly and mitigate damage to the wiring harness(es). Embodiments of the wiring harness housing may furthermore facilitate routing wiring harnesses along opposite directions (e.g., starting through a first open end versus starting through a second open end), which may facilitate assembly, permit overlap of wiring harnesses at the same housing, and reduce risk of damage and electrical conduction.

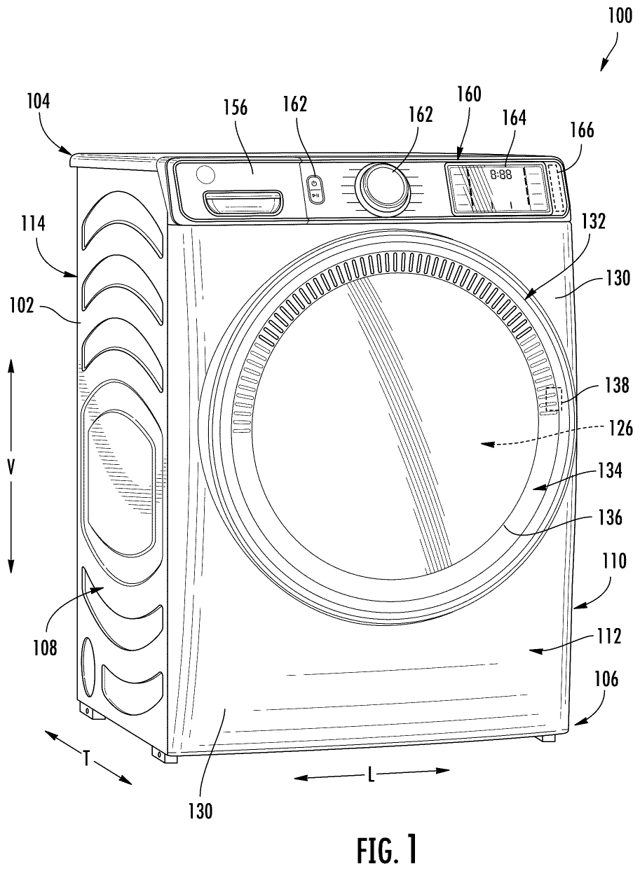

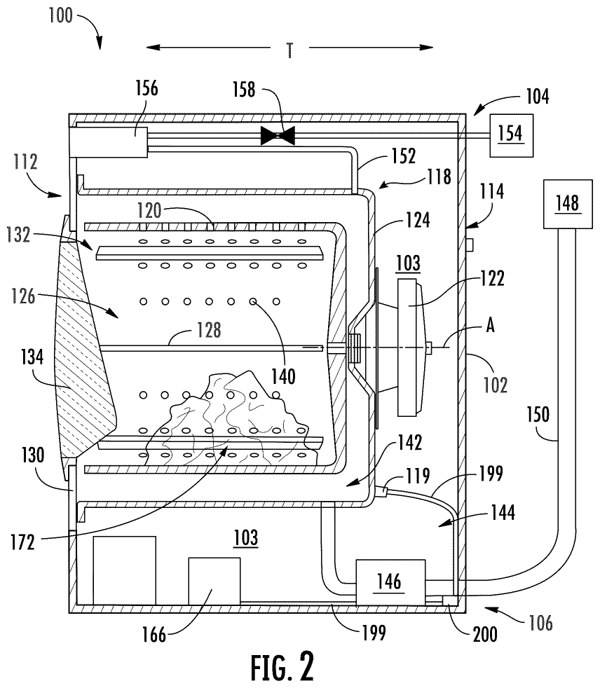

Referring now to the figures, an exemplary appliance that may be used to implement aspects of the present subject matter will be described. Specifically, FIG. 1 is a perspective view of an exemplary washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined.

According to exemplary embodiments, washing machine appliance 100 includes a cabinet 102 that is generally configured for containing and/or supporting various components of washing machine appliance 100 and which may also define one or more internal chambers or compartments of washing machine appliance 100. In this regard, as used herein, the terms “cabinet,” “housing,” and the like are generally intended to refer to an outer frame or support structure for washing machine appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of washing machine appliance 100. By contrast, cabinet 102 may enclose some or all portions of an interior 103 of cabinet 102. It should be appreciated that cabinet 102 may have any suitable size, shape, and configuration while remaining within the scope of the present subject matter.

As illustrated, cabinet 102 generally includes a plurality of walls forming the interior 103. The cabinet 102 generally extends between a top wall 104 and a bottom wall 106 along the vertical direction V, between a first side wall 108 (e.g., the left side when viewed from the front as in FIG. 1) and a second side wall 110 (e.g., the right side when viewed from the front as in FIG. 1) along the lateral direction L, and between a front end 112 and a rear end 114 along the transverse direction T. It should be appreciated that ends 112, 114 may form walls that may be included as portions of other structures or subassemblies, such as subwasher 118. In general, terms such as “left,” “right,” “front,” “rear,” “top,” or “bottom” are used with reference to the perspective of a user accessing washing machine appliance 100.

Referring to FIG. 2, a wash basket 120 is rotatably mounted within cabinet 102 such that it is rotatable about an axis of rotation W. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

According to exemplary embodiments, wash tub 124 may be generally suspended within cabinet 102 by one or more suspension assemblies. In this regard, wash tub 124, wash basket 120, motor 122, and other components of washing machine appliance 100 may be referred to generally herein as a subwasher 118. The subwasher 118 may be separately assembled and installed into cabinet 102, such as through an open front 112 of the cabinet 102 into interior 103.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments. Washing machine appliance 100 may further include a latch assembly 138 (see FIG. 1) that is mounted to cabinet 102 and/or door 134 for selectively locking door 134 in the closed position and/or confirming that the door 134 is in the closed position. Latch assembly 138 may be desirable, for example, to ensure only secured access to wash chamber 126 or to otherwise ensure and verify that door 134 is closed during certain operating cycles or events.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

Washing machine appliance 100 may further include a wash fluid dispenser that is generally configured for dispensing a flow of water, wash fluid, etc. into wash tub 124. For example, a spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present subject matter.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

During operation of washing machine appliance 100, laundry items 172 are loaded into wash basket 120 through opening 132, and washing operation is initiated through operator manipulation of one or more input selectors or using a remote device (see below). Wash tub 124 is filled with water, detergent, and/or other fluid additives, e.g., via spout 152 and/or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items 172 in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

In certain embodiments, control panel 160, with at least one input selector 162, extends from front 112. Control panel 160 and input selector 162 collectively form a user interface input for operator selection of machine cycles and features. A display 164 of control panel 160 indicates selected features, operation mode, a countdown timer, or other items of interest to appliance users regarding operation. Operation of washing machine appliance 100 may be controlled by a controller 166 connected (e.g., electrically coupled) to control panel 160 for user manipulation to select washing machine cycles and features. In response to user manipulation of control panel 160, controller 166 operates the various components of washing machine appliance 100 to execute selected machine cycles and features.

Controller 166 may include a memory (e.g., non-transitive media) and microprocessor, such as a general or special purpose microprocessor operable to execute programming instructions or micro-control code associated with a selected machine cycles and features (e.g., as part of a washing operation). The memory may represent random access memory such as DRAM, or read only memory such as ROM or FLASH. In certain embodiments, the processor executes programming instructions stored in memory. The memory may be a separate component from the processor or may be included onboard within the processor. Alternatively, controller 166 may be constructed without using a microprocessor (e.g., using a combination of discrete analog or digital logic circuitry, such as switches, amplifiers, integrators, comparators, flip-flops, AND gates, and the like) to perform control functionality instead of relying upon software. Control panel 160 and other components of washing machine appliance 100 (e.g., one or more sensors, such as a pressure sensor mounted to tub 121) may be in communication with controller 166 via one or more signal lines or shared communication busses.

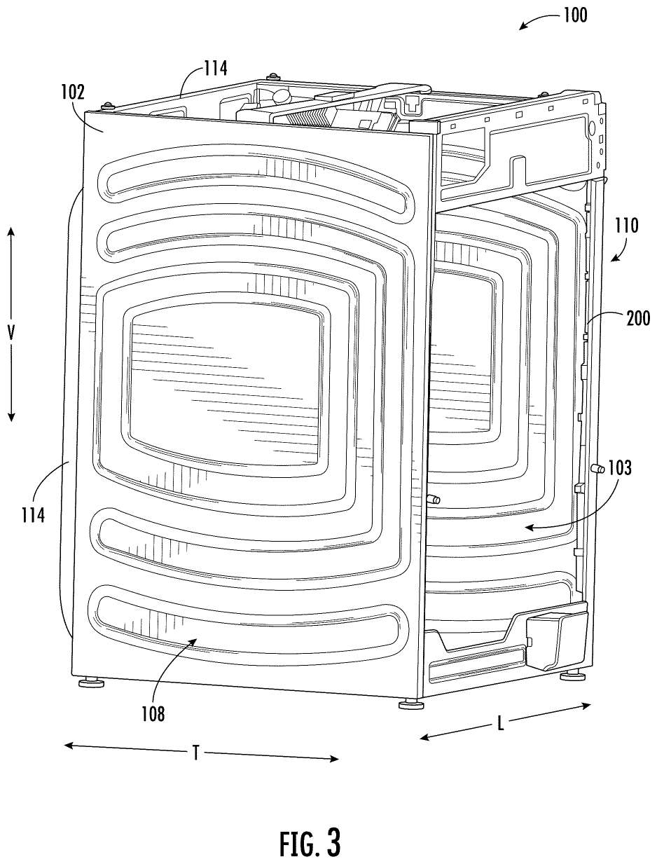

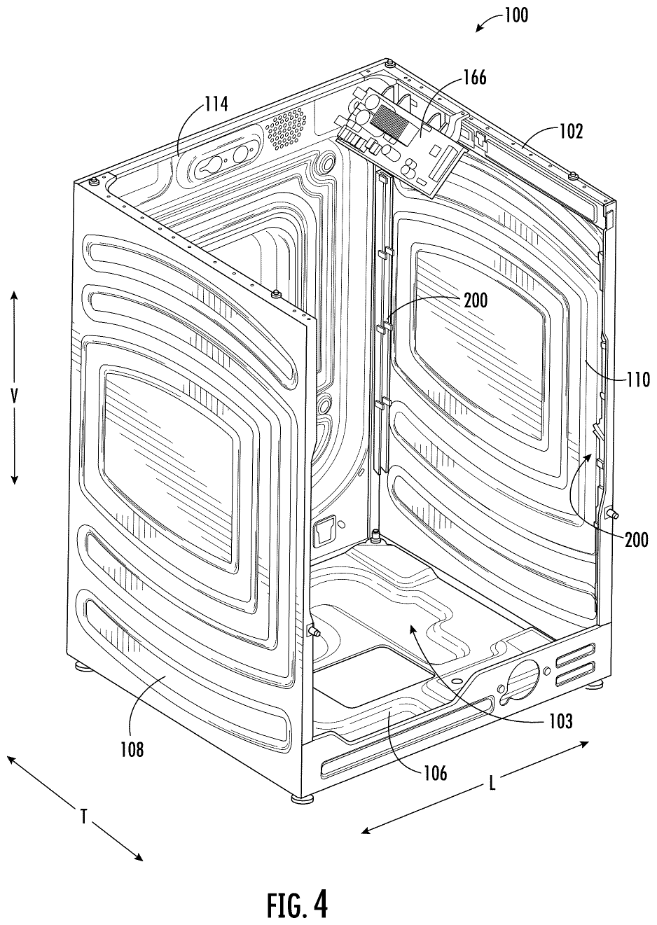

FIG. 2 depicts a section view of washing machine appliance 100 that is a front load washing machine. FIGS. 3-5 depict perspective views of a cabinet 102 defining an interior 103 at which operable components of an appliance are generally positioned, such as the subwasher 118 extendable into the cabinet 102 through the front end 112 such as described above and generally herein. FIGS. 3-5 further depict exemplary positions at which controller 166 may be positioned at cabinet 102 within interior 103, such as mounted onto one or more walls (e.g., 104, 106, 108, 110) of the cabinet 102. A wiring harness housing 200 is attached to the cabinet 102 to facilitate routing of wires or leads of a wiring harness assembly 199 at the appliance 100, such as from controller 166 to electrically-driven or electronically-controlled components of the appliance, such as at the subwasher 118, door 134 (e.g., a lock or sensor), control panel 160, input selector 162, display 164, or portion of the cabinet 102 proximate to one or more electrical or electronic components, or other such operable components of an appliance.

Washing machine appliance 100 is shown in FIGS. 1 and 2 as a front loading washing machine, as an example. It should be appreciated that embodiments of the harness housing 200 provided herein may be included at appliance cabinets generally, such as, but not limited to, dryer appliances, refrigeration appliances, freezer appliances, or dishwashing appliances. In various embodiments, the cabinet 102 includes a plurality of walls (e.g., combinations of some or all of walls 104, 106, 108, 110) forming the interior 103 at which an electrically-driven component (e.g., subwasher 118) is disposable. Embodiments of the wiring harness housing 200 are attachable to the cabinet 102 at one or more of the walls and provide a routing path between the controller 166 and a receiving interface 119 at the electrically-driven component, such as the subwasher 118.

In various embodiments depicted and described herein, the wiring harness assembly 199 includes a first wiring harness 201 and a second wiring harness 202. The wiring harnesses 201, 202 may be configured to transmit signals, commands, energy, or other electrical signals as may be appropriate and generally understood for an appliance.

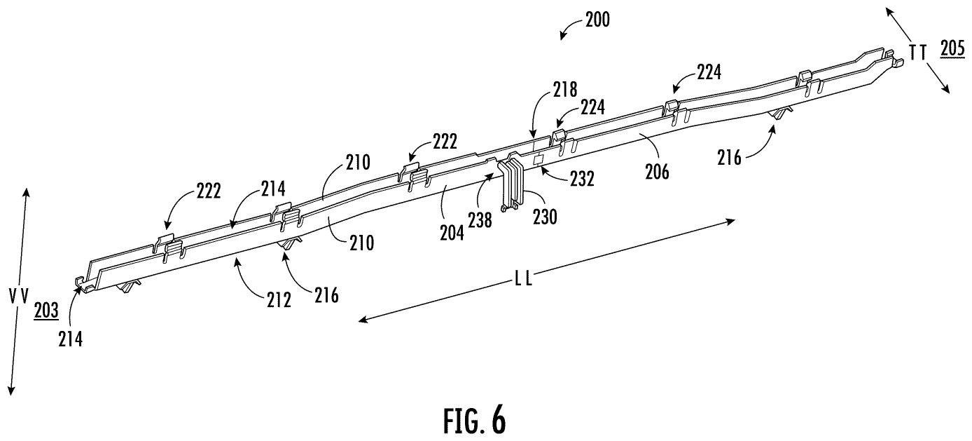

Referring now to FIGS. 6-18, views of an embodiment of the wiring harness housing 200 are provided. The housing 200 includes a plurality of sidewalls 210, 212 extending substantially along a lengthwise direction LL. The plurality of sidewalls 210, 212 form a routing passage 214 extending substantially along the lengthwise direction LL.

In various embodiments, the plurality of sidewalls includes a base wall 212 from which one or more passage walls 210 extend, such as a first sidewall and a second sidewall. The routing passage 214 is formed between the base wall 212 and the one or more passage walls 210, such as the first sidewall and the second sidewall.

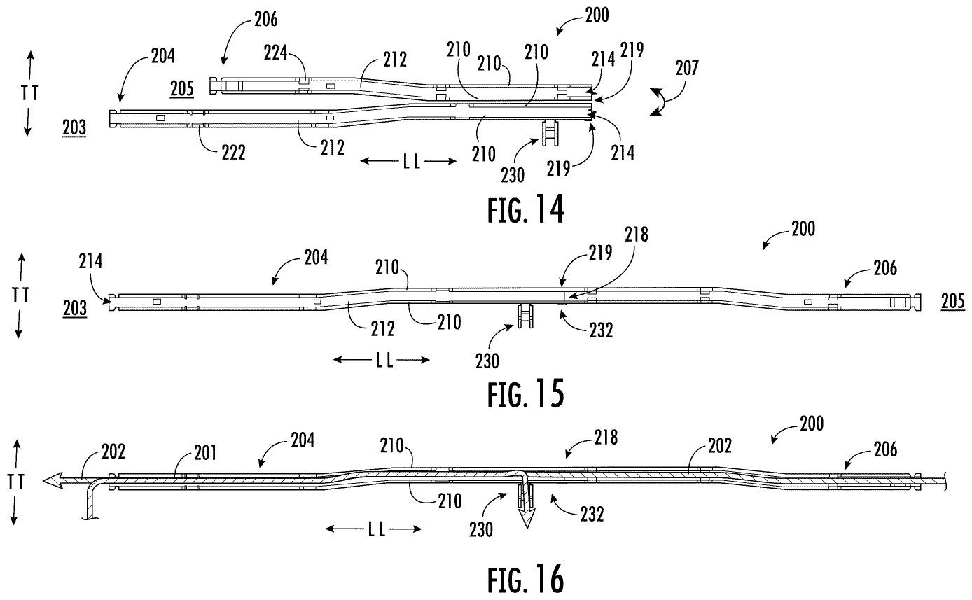

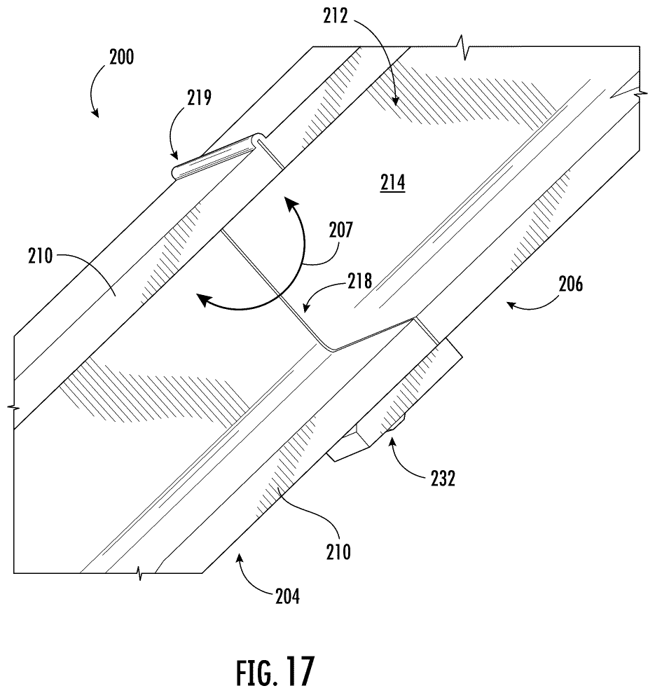

The housing 200 may include a first housing portion 204 rotatable relative to a second housing portion 206 at a detachment interface 218 at which a hinge 219 is positioned at at least one of the plurality of sidewalls (depicted in detail at FIG. 17). The detachment interface 218 extends across the plurality of sidewalls 210, 212 and delineates the first housing portion 204 from the second housing portion 206. The hinge 219 permits the housing 200 to bend or flex (e.g., along direction of rotation 207) at the hinge 219 to position the first housing portion 204 and second housing portion 206 substantially alongside one another along the lengthwise direction LL in a folded state, such as depicted in FIG. 14.

In an unfolded state (e.g., depicted in FIGS. 8-9, FIG. 11, and FIGS. 15-16), the plurality of sidewalls 210, 212 form the routing passage 214 extending along the lengthwise direction LL between a first open end 203 and a second open end 205. The first open end 203 is positioned at the first housing portion 204 and the second open end 205 at the second housing portion 206. The detachment interface 218 is positioned along the lengthwise direction LL between the open ends 203, 205.

In various embodiments, the housing 200 is formed of a compliant material allowing for the plurality of sidewalls 210, 212 and the hinge 219 to form a unitary, monolithic component permitting rotation (e.g., along direction 207) of the first and second housing portions 204, 206 relative to one another, such as depicted between FIGS. 14-15. The compliant material may include a plastic material, such as, but not limited to, a polypropylene material, a polyethylene material, or an acrylonitrile butadiene styrene (ABS) material. The hinge 219 is formed as a living hinge or integral hinge. The hinge 219 forms a flexure from the same material as the first housing portion 204, and the second housing portion 206 connected at the hinge 219. The housing 200 including the first and second housing portions 204, 206 connected to one another at the hinge 219 may be formed from any appropriate manufacturing process, such as, but not limited to, an injection molding process.

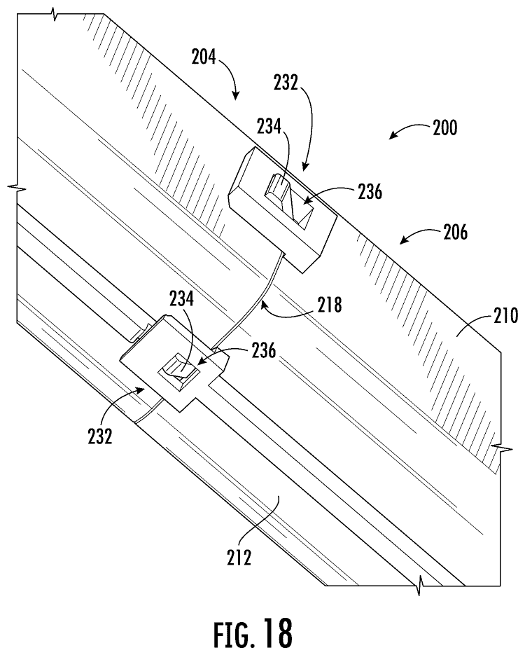

Referring now to FIGS. 17-18, in some embodiments, at least one of the plurality of sidewalls 210, 212 includes a lock 232 at the detachment interface 218 between the first housing portion 204 and the second housing portion 206. The lock 232 is configured to selectively couple the first housing portion 204 to the second housing portion 206 to inhibit rotation (e.g., along direction 207) of the first and second housing portions 204, 206 at the hinge 219.

Referring to FIG. 18, in some embodiments, the lock 232 includes a latch 234 extending from one of the first housing portion 204 or the second housing portion 206. The other of the first housing portion 204 or second housing portion 206 includes a latch receiver opening 236 configured to receive the latch 234. As such, the lock 232 may include a latch mechanism selectively attaching the first and second housing portions 204, 206 into the unfolded state. In various embodiments, the lock 232 is formed integrally at one or more of the plurality of sidewalls 210, 212, such that the housing 200 forms a unitary, monolithic component including the plurality of sidewalls 210, 212, the hinge 219 rotatably connecting the first housing portion 204 and the second housing portion 206, and the lock 232.

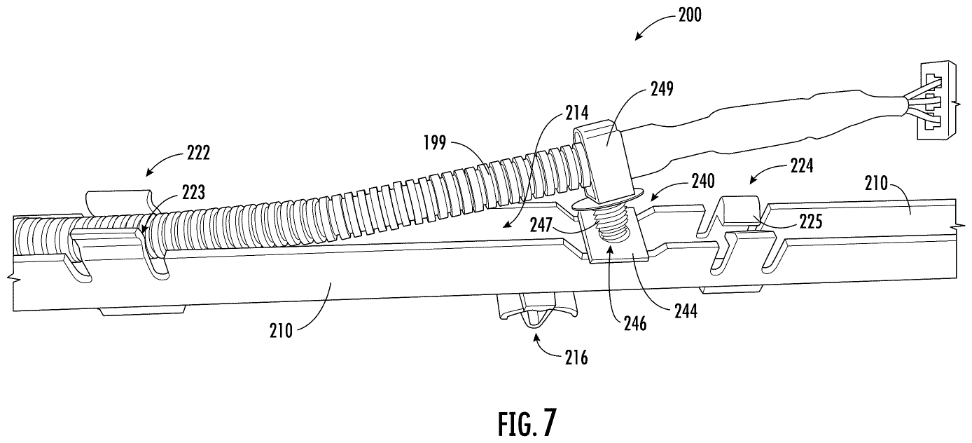

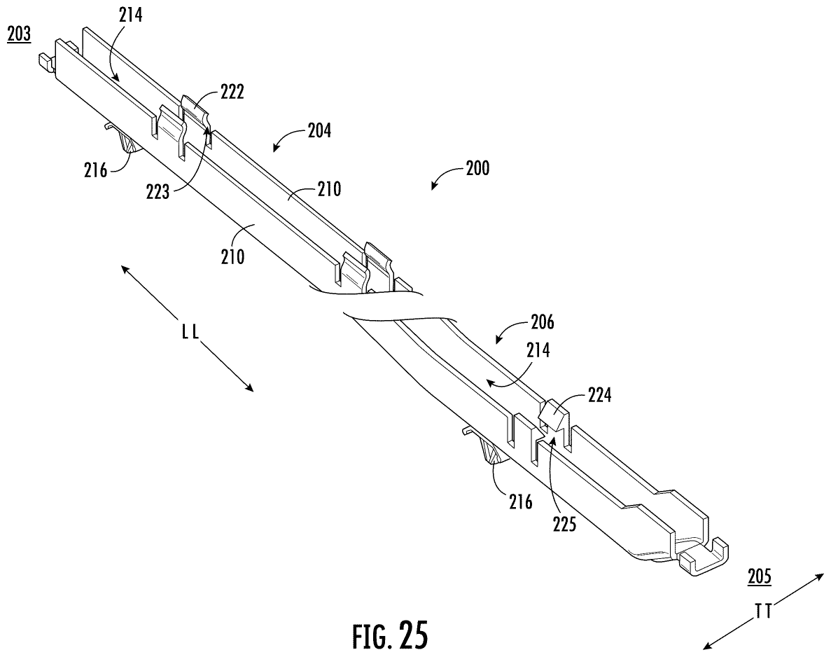

In various embodiments, such as depicted in FIGS. 7 and 25, the housing 200 includes a plurality of harness attachment interfaces 222, 224 positioned along the lengthwise direction LL at the plurality of sidewalls. Referring to FIG. 7, the plurality of harness attachment interfaces 222, 224 are configured to retain the wiring harness assembly 199 to the housing 200 along the routing passage 214.

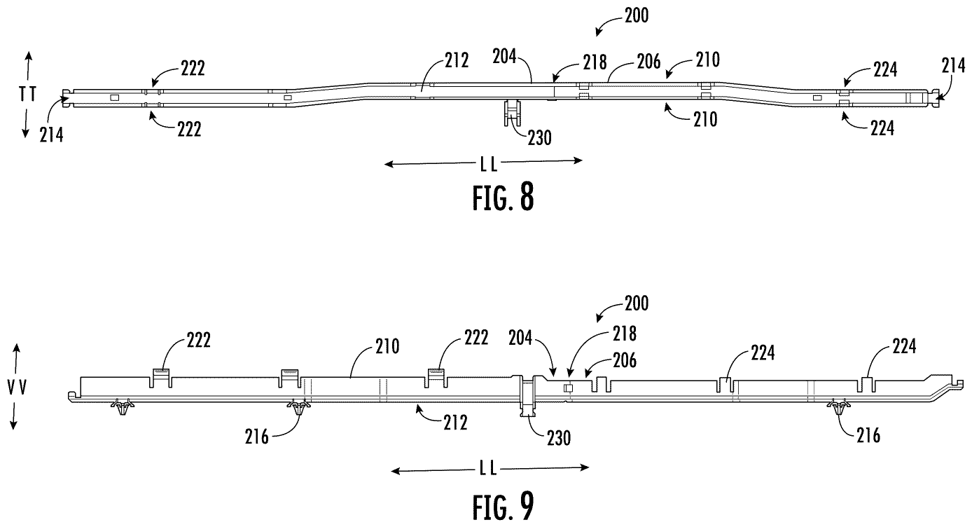

Referring to FIGS. 8-9, in still various embodiments, the plurality of harness attachment interfaces includes a first harness attachment interface 222 positioned at the first housing portion 204. The plurality of harness attachment interfaces includes a second harness attachment interface 224 positioned at the second housing portion 206. Referring briefly to FIG. 14, in the folded state, the first harness attachment interface 222 is positioned at the first housing portion 204 and the second harness attachment interface 224 is positioned at the second housing portion 206.

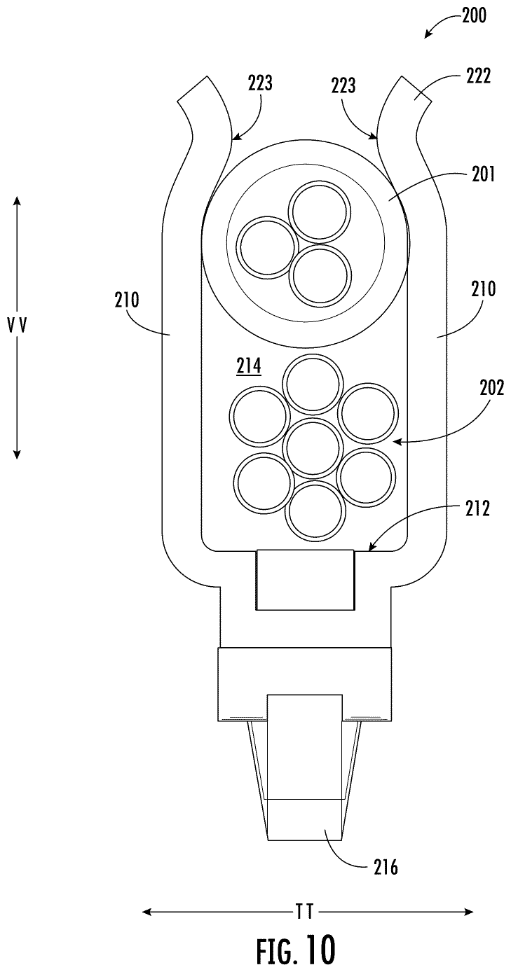

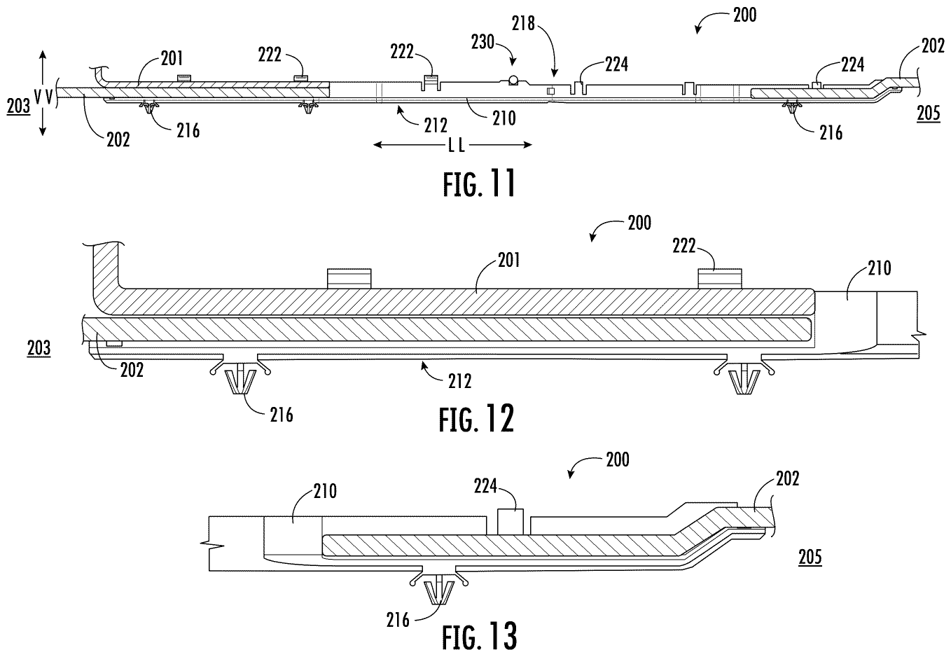

In still various embodiments, the housing 200 may include a first harness attachment interface 222 positioned vertically outward (along vertical axis VV) relative to a second harness attachment interface 224, or relative to the base wall 212, such as depicted in the cross-sectional view in FIG. 10. FIG. 11 further depicts a side view of the housing 200 including the first wiring harness 201 routing along the routing passage 214 vertically outward along vertical axis VV from the second wiring harness 202 routing along the routing passage 214 (e.g., second wiring harness 202 routing more proximate to base wall 212 along the vertical axis VV than the first wiring harness 201). The first harness attachment 222 is configured to receive the first wiring harness 201 along the routing passage 214 vertically outward (along axis VV) from the second harness attachment 224 configured to receive the second wiring harness 202 along the routing passage 214. As such, the first wiring harness 201 and the second wiring harness 202 are extendable into the routing passage 214 in vertically adjacent arrangement to one another, such as depicted in further detail in FIG. 12.

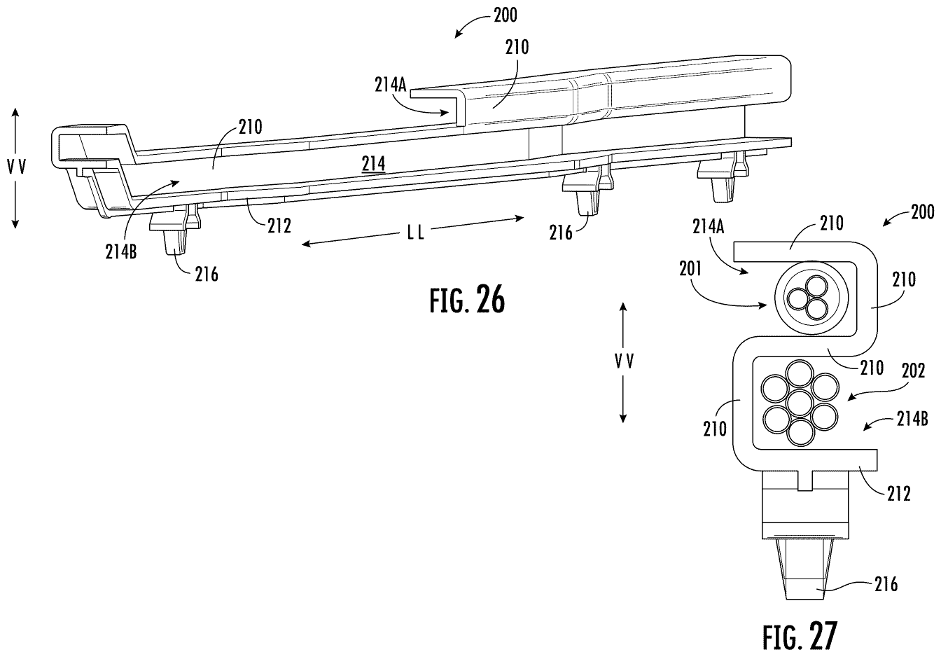

In various embodiments, the plurality of sidewalls 210, 212 extends along the vertical axis VV to extend the routing passage 214 to receive the first and second wiring harnesses 201, 202 between the passage walls 210 and in vertically adjacent arrangement to one another, such as depicted generally in FIGS. 6-18. In some embodiments, the plurality of sidewalls 210, 212 forms a first routing passage positioned vertically outward of a second routing passage, such as to receive the first and second wiring harnesses 201, 202 in vertically adjacent arrangement to one another. Referring briefly to FIGS. 26-27, in an embodiment, at least one of the plurality of sidewalls, such as passage wall 210, separates the routing passage 214 along the vertical axis VV into a first routing passage 214A and a second routing passage 214B from one another. As such, one or more of the passage walls 210 provides a barrier physically and/or electrically separating the first and second wiring harnesses 201, 202 from one another.

As more clearly depicted in FIG. 7, FIG. 10, and FIG. 25, the first harness attachment interface 222 may include a first clamping section 223 extending inward along a transverse axis TT, such as toward one another to form a narrowing cross-sectional area (e.g., depicted in FIG. 10). The second harness attachment interface 224 may include a second clamping section 225 extending inward along the transverse axis TT into the routing passage 214, such as toward a center of the routing passage 214 from the passage walls 210. The plurality of harness attachment interfaces 222, 224 may form clips (e.g., saddle clips), concave walls, pincers, or contact points to receive the wiring harness 201, 202. Interfaces 222, 224 may form a detent or barrier extending along the vertical axis VV over the routing passage 214, such as may limit movement of the wiring harness along the vertical axis VV, while including an opening (e.g., between respective clamping sections 223, 225 along the transverse axis TT) permitting selective positioning of the wiring harness 201, 202 into the routing passage 214.

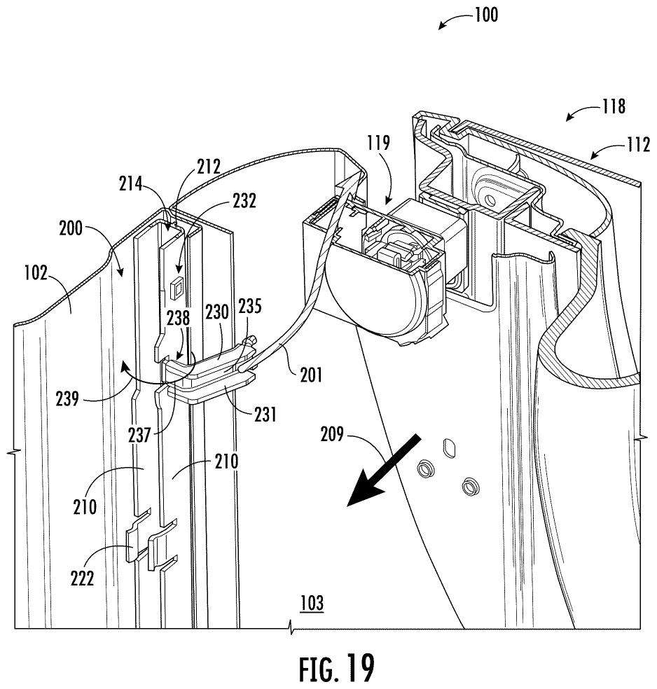

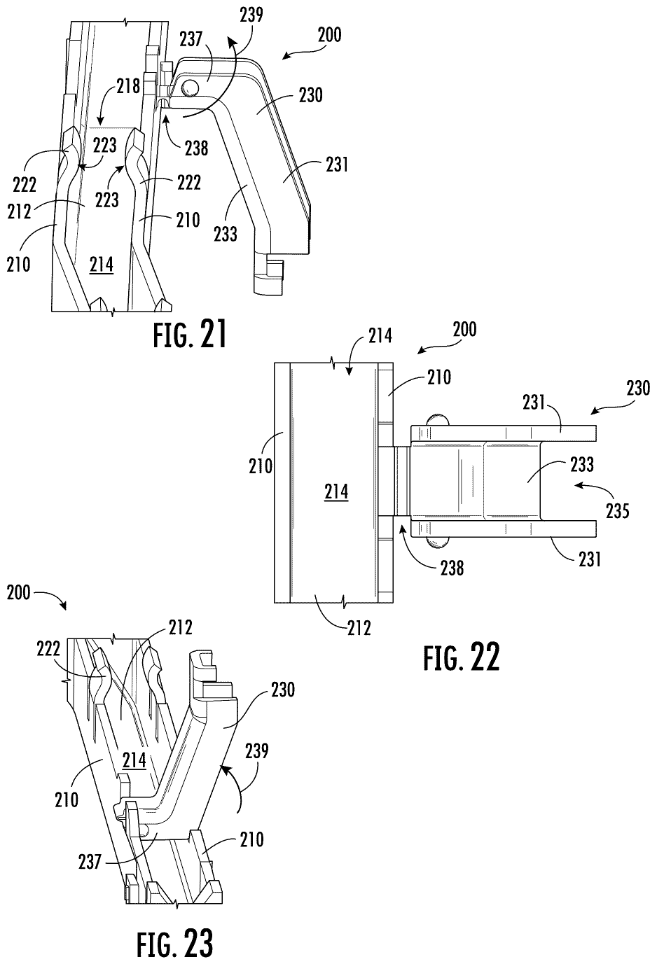

Referring now to FIGS. 19-23, the housing 200 may include a clip 230 extending from one of the plurality of sidewalls, such as passage wall 210 depicted in FIGS. 21-23. The clip 230 forms a clip routing passage 235 (FIG. 22) extending from the routing passage 214 formed from the plurality of sidewalls 210, 212. At least a portion of the wiring harness assembly 199 is extendable from the routing passage 214 through the clip routing passage 235. The clip 230 extends from one of the plurality of sidewalls 210, 212 along the lengthwise direction LL between ends 203, 205. For instance, the clip 230 may be positioned proximate to the detachment interface 218, such as along an approximate midway distance along the lengthwise direction LL between ends 203, 205. However, it should be appreciated that housing 200 may include one or more clips 230 positioned along the lengthwise direction LL between ends 203, 205.

In various embodiments, the clip 230 includes a plurality of clip sidewalls 231, 233 forming the clip routing passage 235. The plurality of clip sidewalls may include a base clip wall 233 and one or more clip passage walls 231. A hinge 238 (e.g., a clip hinge) rotatably connects the clip 230 to one of the plurality of sidewalls, such as the passage wall 210 as depicted in FIGS. 21-23. The hinge 238 includes a living hinge or integral hinge formed integrally, unitarily, and monolithically with the plurality of sidewalls 210, 212, such as described in regard to hinge 219. As such, clip 230 is configured to rotate, such as along direction of rotation 239, to extend from one sidewall (e.g., a first passage wall 210) to another, opposing sidewall (e.g., a second passage wall 210).

Referring still to FIGS. 21-23, in some embodiments, the clip 230 may include a bridge or curved portion 237 extending across the sidewalls 210 when in a folded position, such as depicted in FIG. 23. The bridge or curved portion 237 may position clip sidewalls 231, 233 along a substantially perpendicular direction relative to the curved portion 237, such as may position the clip 230 extending substantially along the vertical axis VV when bent or flexed from an unfolded position (FIG. 21) to the folded position (FIG. 23).

In various embodiments, the clip 230 is formed integrally at one or more of the plurality of sidewalls 210, 212, such that the housing 200 forms a unitary, monolithic component including the plurality of sidewalls 210, 212, the hinge 219 rotatably connecting the first housing portion 204 and the second housing portion 206, the hinge 238 rotatably connecting the clip 230 and the sidewall (e.g., passage wall 210), or additionally, the lock 232. In still various embodiments, the housing 200 forms a unitary, monolithic component including the plurality of sidewalls 210, 212, the first harness attachment interface 222, the second harness attachment interface 224, and the hinge 219, 238, or additionally, the clip 230, or additionally, the lock 232.

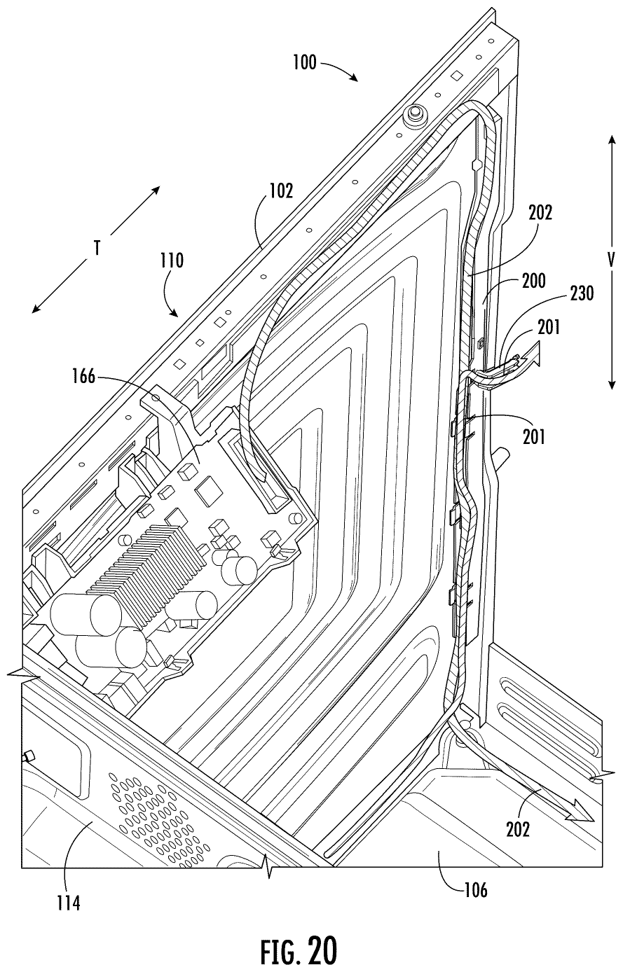

In an exemplary embodiment, referring to FIGS. 19-20, the first wiring harness 201 is depicted extending from the routing passage 214 and into the clip routing passage 235 (a portion of the first wiring harness 201 is depicted in FIG. 19 for clarity). The first wiring harness 201 egresses from a lengthwise portion of the housing 200 (e.g., between ends 203, 205 along the lengthwise direction LL), such as depicted in FIG. 20. The first wiring harness 201 egresses from the clip routing passage 235, such as along a direction substantially perpendicular to the lengthwise direction LL. The first wiring harness 201 egressing as such may connect to the electrically-driven component (e.g., subwasher 118) at the electrically operable component 119, such as depicted in FIG. 19.

Referring still to FIGS. 19-20, the sidewalls 210, 212 may provide protection to the wiring harness 201, 202 as the electrically-driven component (e.g., subwasher 118) is translated from the front end 112 into the interior 103, such as depicted along direction of translation 209 (FIG. 19). In the embodiment depicted in FIG. 19, the subwasher 118 may contact the clip 230 as the subwasher 118 is translated into the interior 103 along direction 209. The subwasher 118 pushes the clip 230 to rotate along direction 239 at the hinge 238, such as to translate the clip 230 from the unfolded position (e.g., FIG. 21) to the folded position (e.g., FIG. 23). As such, the clip 230 is moved such as to avoid undesired friction and potential damage from installing the subwasher 118 into the cabinet 102.

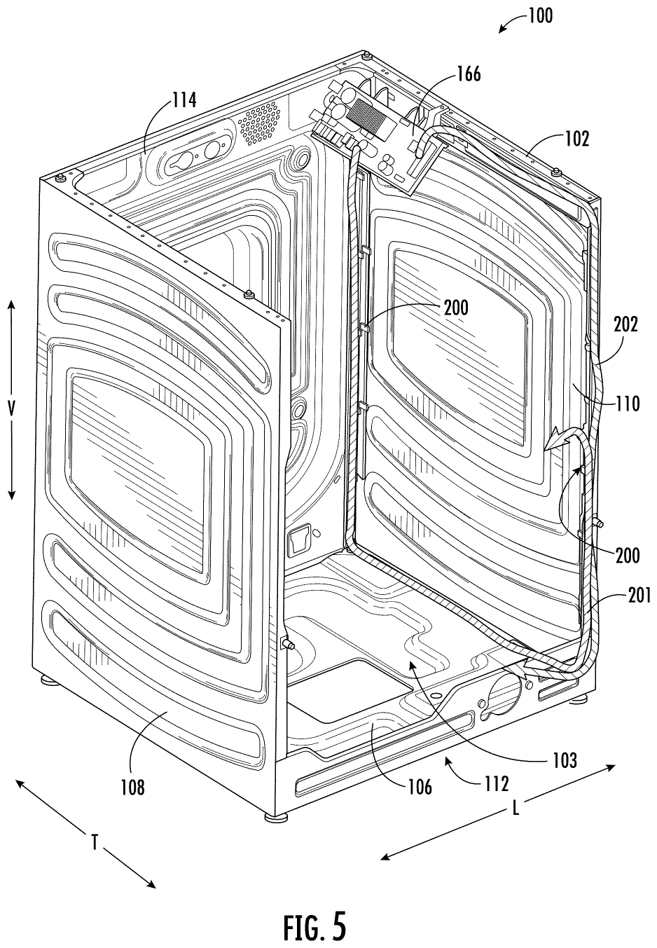

Referring to FIG. 20, and at least partially depicted in FIG. 5 and FIGS. 11-13, in an exemplary embodiment, the second wiring harness 202 is extendable through the routing passage 214 along the lengthwise direction LL between the first open end 203 at the first housing portion 204 and the second open end 205 at the second housing portion 206. The first wiring harness 201 is extendable through the routing passage 214 along the lengthwise direction LL between the first open end 203 at the first housing portion 204 and the clip 230 extending from one of the plurality of sidewalls, such as passage wall 210. As such, embodiments of the housing 200 may facilitate routing a wiring harness along a wall while routing another wiring harness (or another portion of the wiring harness) to an electrically-driven component positioned along the lengthwise direction LL between ends 203, 205. The housing 200 may furthermore provide protection to the wiring harness, such as from translation of subassemblies that may otherwise contact the wiring harness mounted to the cabinet.

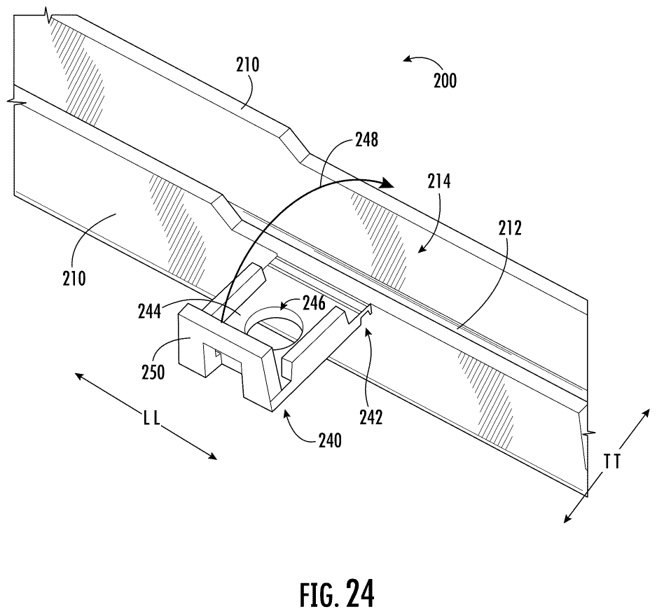

Referring to FIG. 24, and further depicted in FIG. 7, the housing 200 may include a harness retainer attachment interface 240 configured to provide a retention interface for the wiring harness 199. In some embodiments, the wiring harness 199 may include a retainer clip 249 including a fastener 247, such as a mechanical fastener such as described in regard to housing attachment interface 216. The harness retainer attachment interface 240 may include a platform 244 including a platform opening 246 into which the fastener 247 is extendable. In some embodiments, the harness retainer attachment interface 240 includes a hinge 242 connecting the platform 244 to at least one of the plurality of sidewalls 210, 212, such as passage wall 210 depicted in FIG. 7. Hinge 242 is configured substantially similarly as described in regard to hinge 219, 238. As such, hinge 242 includes a living hinge or integral hinge configured to rotate the platform 240 over the routing passage 214, such as along direction of rotation 248 (FIG. 24).

In still some embodiments, the harness retainer attachment interface 240 includes a latch wall 250 configured to secure onto an opposing sidewall (e.g., passage wall 210) opposite of the sidewall at which the platform 244 is attached at hinge 242.

The harness retainer attachment interface 240 may include the platform 244 and platform opening 246 configured to receive the retainer clip 249, such as the fastener 247, from the wiring harness assembly 199. The harness retainer attachment interface 240 may attach the wiring harness assembly 199 to the housing 200 along the lengthwise direction LL of the routing passage 214 and outward along the vertical axis VV from the routing passage 214. For instance, the harness retainer attachment interface 240 may provide a retention or guiding feature for an upper wiring harness, such as first wiring harness 201 depicted in FIG. 20.

Referring back to FIGS. 6-7 and FIGS. 11-13, in various embodiments, the housing 200 includes a housing attachment interface 216 extending from at least one of the plurality of sidewalls 210, 212, such as base wall 212. The housing attachment interface 216 may include a mechanical fastener configured to connect the housing 200 to the cabinet 102. The mechanical fastener may include a fir tree fitting, a Christmas tree fitting, a threaded shank (e.g., screw, bolt, tie rod, etc.) and retainer (e.g., nut, nut plate, lock, etc.), or other appropriate type of fastening device or adhesive.

Embodiments of the hinges depicted and described herein may form living hinges or integral hinges configured permit rotation of the attached component substantially 180 degrees. Still various embodiments of the housing 200 may include a plurality of hinges, such as a plurality of hinge 219 along the lengthwise direction LL, such as may permit bending, flexing, and folding of a plurality of housing portions (e.g., two or more housing portions) such as described herein.

Various embodiments of the wiring harness housing 200 depicted and described herein include an integrally-formed, unitary, monolithic component including features such as depicted and described herein. Embodiments such as depicted and described herein provide a single-component solution for providing a wiring harness housing, routing, and protection. For instance, such as described herein, embodiments of the housing 200 may mitigate or eliminate damage related to installing subassemblies into a cabinet. Embodiments of the housing 200 may further provide routing and retention features, such as may facilitate connection to a subassembly (e.g., from outside of the cabinet) and permit installation of the subassembly into the cabinet while mitigating or eliminating rubbing, friction, or damage to the wiring harness.

Embodiments of the housing 200 may properly restrain one or more wiring harnesses at an appliance, such as to prevent unsafe operating conditions, mitigate losses in appliance function, and avoid damage to the wiring harness during assembly and operation. Still further, embodiments of the housing 200 may mitigate undesired vibration, noise, and electromagnetic interference. Additionally, or alternatively, embodiments of the housing 200 may facilitate routing and restraining a plurality of wiring harnesses, including harnesses overlapping or crossing one another or occupying similar spaces within the cabinet of the appliance.

Although depicted and described substantially with regard to washing machine assemblies, embodiments of the housing 200 depicted and described herein may be included generally at appliances including one or more wiring harnesses, or furthermore, including one or more electrically-driven and/or electronically-controlled assemblies or subassemblies to which the one or more wiring harnesses operably connect (e.g., to provide electrical signals, energy, etc.). For instance, the appliance may include a refrigeration appliance, a freezer appliance, a dishwashing appliance, a dryer appliance, or other appliance such as may include a cabinet, a wiring harness, and one or more electrically-driven and/or electronically-controlled components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
a cabinet comprising a plurality of walls, the plurality of walls forming an interior into which an electrically-driven component is disposable;
a controller configured to operate the electrically-driven component;
a wiring harness assembly operably coupling the controller and the electrically-driven component, wherein the wiring harness assembly comprises a first wiring harness and a second wiring harness; and
a wiring harness housing through which the wiring harness assembly is routed, the wiring harness housing comprising:
a plurality of sidewalls forming a routing passage extending along a lengthwise direction between a first open end and a second open end, wherein the first wiring harness and the second wiring harness are extendable into the routing passage in vertically adjacent arrangement to one another,
wherein the plurality of sidewalls and routing passage extend substantially along the lengthwise direction,
wherein the wiring harness housing comprises a first harness attachment interface and a second harness attachment interface, the first harness attachment interface positioned vertically outward relative to the second harness attachment interface, wherein the first harness attachment is configured to receive the first wiring harness along the routing passage vertically outward from the second harness attachment configured to receive the second wiring harness along the routing passage, and
wherein the wiring harness housing comprises a unitary, monolithic component comprising the plurality of sidewalls, the first harness attachment interface, and the second harness attachment interface.

2. The appliance of claim 1, wherein the plurality of sidewalls forms the routing passage extending along the lengthwise direction between the first open end and the second open end.

3. The appliance of claim 1, wherein the first harness attachment interface comprises a first clamping section extending inward along a transverse axis, and wherein the second harness attachment interface comprises a second clamping section extending inward along the transverse axis into the routing passage.

4. The appliance of claim 1, wherein the wiring harness housing comprises a clip extending from one of the plurality of sidewalls, wherein the clip forms a clip routing passage extending from the routing passage formed from the plurality of sidewalls, and wherein at least a portion of the wiring harness assembly is extendable from the routing passage through the clip routing passage.

5. The appliance of claim 4, wherein a hinge rotatably connects the clip to the sidewall to permit the clip to rotate to another one of the plurality of sidewalls.

6. The appliance of claim 5, wherein the hinge comprises a living hinge, and wherein the wiring harness housing comprises the unitary, monolithic component comprising the plurality of sidewalls, the first harness attachment interface, the second harness attachment interface, and the second hinge rotatably connecting the clip to one of the plurality of sidewalls.

7. The appliance of claim 1, wherein the second wiring harness is extendable through the routing passage along the lengthwise direction between the first open end and the second open end, and wherein the first wiring harness is extendable through the routing passage along the lengthwise direction between the first open end at the first housing portion and a clip extending from one of the plurality of sidewalls, and wherein the clip forms a clip routing passage extending from the routing passage, and wherein the first wiring harness assembly is extendable from the routing passage through the clip routing passage.

8. The appliance of claim 1, wherein the plurality of sidewalls comprises a base wall from which a first sidewall and a second sidewall extend, wherein the routing passage is formed between the base wall, the first sidewall, and the second sidewall.

9. The appliance of claim 8, wherein the wiring harness housing comprises a first housing portion rotatable relative to a second housing portion at a hinge, wherein the hinge permits the wiring harness housing to bend at the hinge to position the first housing portion and second housing portion alongside one another along the lengthwise direction, wherein a detachment interface extends across the plurality of sidewalls, and wherein the hinge is positioned at the detachment interface, and wherein the first housing portion and the second housing portion each extend from the detachment interface, and wherein the first housing portion and the second housing portion are rotatable relative to one another at the hinge at the detachment interface.

10. The appliance of claim 8, wherein the plurality of sidewalls forms a first routing passage positioned vertically outward of a second routing passage, and wherein at least one of the plurality of sidewalls separates the first and second routing passages from one another.

11. A wiring harness housing for an appliance, the wiring harness housing comprising:
a plurality of sidewalls forming a routing passage extending along a lengthwise direction between a first open end and a second open end,
wherein the plurality of sidewalls and routing passage extend substantially along the lengthwise direction,
wherein the wiring harness housing comprises a first harness attachment interface and a second harness attachment interface, the first harness attachment interface positioned vertically outward relative to the second harness attachment interface, wherein the first harness attachment is configured to receive a first wiring harness along the routing passage vertically outward from a second harness attachment configured to receive the second wiring harness along the routing passage,
wherein the wiring harness housing comprises a first housing portion rotatable relative to a second housing portion at a hinge at one of the plurality of sidewalls, wherein the hinge permits the wiring harness housing to bend at the hinge to position the first housing portion and second housing portion alongside one another along the lengthwise direction, and
wherein the wiring harness housing comprises a unitary, monolithic component comprising the plurality of sidewalls, the first harness attachment interface, the second harness attachment interface, and the hinge.

12. The wiring harness of claim 11, wherein the plurality of sidewalls forms the routing passage extending along the lengthwise direction between the first open end at the first housing portion and the second open end at the second housing portion.

13. The wiring harness of claim 11, wherein the first harness attachment interface comprises a first clamping section extending inward along a transverse axis, and wherein the second harness attachment interface comprises a second clamping section extending inward along the transverse axis into the routing passage.

14. The wiring harness of claim 11, wherein the wiring harness housing comprises a clip extending from one of the plurality of sidewalls, wherein the clip forms a clip routing passage extending from the routing passage formed from the plurality of sidewalls, and wherein at least a portion of the wiring harness assembly is extendable from the routing passage through the clip routing passage.

15. The wiring harness of claim 14, wherein a second hinge rotatably connects the clip to the sidewall to permit the clip to rotate to another one of the plurality of sidewalls.

16. The wiring harness of claim 15, wherein the hinge and the second hinge comprise a living hinge, and wherein the wiring harness housing comprises the unitary, monolithic component comprising the plurality of sidewalls, the first harness attachment interface, the second harness attachment interface, the hinge rotatably connecting the first housing portion and the second housing portion, and the second hinge rotatably connecting the clip to one of the plurality of sidewalls.

17. The wiring harness of claim 11, wherein the second wiring harness is extendable through the routing passage along the lengthwise direction between the first open end at the first housing portion and the second open end at the second housing portion, and wherein the first wiring harness is extendable through the routing passage along the lengthwise direction between the first open end at the first housing portion and a clip extending from one of the plurality of sidewalls, and wherein the clip forms a clip routing passage extending from the routing passage, and wherein the first wiring harness assembly is extendable from the routing passage through the clip routing passage.

18. The wiring harness of claim 11, wherein the plurality of sidewalls comprises a base wall from which a first sidewall and a second sidewall extend, wherein the routing passage is formed between the base wall, the first sidewall, and the second sidewall.

19. The wiring harness of claim 18, wherein a detachment interface extends across the plurality of sidewalls, and wherein the hinge is positioned at the detachment interface, and wherein the first housing portion and the second housing portion each extend from the detachment interface, and wherein the first housing portion and the second housing portion are rotatable relative to one another at the hinge at the detachment interface.

20. The wiring harness of claim 18, wherein the plurality of sidewalls forms a first routing passage positioned vertically outward of a second routing passage, and wherein at least one of the plurality of sidewalls separates the first and second routing passages from one another.
